(19) United States
(12) Patent Application Publication
(10) Pub. No.: US 2006/0095288 A1
(43) Pub. Date: May 4, 2006

(54) Transaction network

(75) Inventors: Jennifer Amys, Bloomington, MN (US); Chung Crowley, Redondo Beach, CA (US)

Correspondence Address: Schwegman, Lundberg, Woessner & Kluth, P.A., P.O. Box 2938, Minneapolis, MN, 55402, US

(73) Assignee: Upstream Software, Inc.

(21) Appl. No.: 11/260,284

(22) Filed: Oct. 27, 2005

Related U.S. Application Data
(60) Provisional application No. 60/623,684, filed on Oct. 29, 2004.
(60) Provisional application No. 60/625,392, filed on Nov. 5, 2004.

(51) Int. Cl. G06Q 99/00; G05B 19/418

(52) U.S. Cl. 705/1; 705/8

(57) ABSTRACT

The systems, methods, and software of the present subject matter utilize data translation objects in translating data between trading partner specific data formats and a general data format. Each trading partner creates a data translation object for translating data to and from their proprietary formats to the general format. Upon creation of a data translation object, a trading partner is automatically enabled to exchange data with any other trading partner having created its own data translation object.

### CROSS-REFERENCE TO RELATED APPLICATIONS

The present application claims priority to U.S. Provisional Application Ser. No. 60/623,684, filed Oct. 29, 2004; and U.S. Provisional Application Ser. No. 60/625,392, filed Nov. 5, 2004; each of which is incorporated herein by reference in its entirety.

### TECHNICAL FIELD

The inventive subject matter relates to data processing, and more particularly to exchanging data electronically between disparate computing systems.

### BACKGROUND

Companies have been exchanging business transactions electronically for decades. First, via computer tapes that were physically transported from one trading partner to the other, and then through the global standards called Electronic Data Interchange (EDI). Value Added private computer Networks (VAN) functioned as postal offices for electronic transactions, where businesses used modems and phone lines to dial into their VANs to drop off and pickup their electronic transactions. VAN operators, over the years, have had a near monopoly hold on the EDI transport business. Consequently, the cost of using their services was high and only the largest companies could afford to do EDI. Smaller companies mandated by their large trading partners, looking for cheaper ways to comply with the mandates, often utilizing counter productive methods such as EDI-to-FAX, or Print-n-Rip solution.

With the ubiquity of the Internet, businesses can now connect to one another directly. VAN is no longer a must when exchanging electronic transactions. Accelerating this trend was the approval of secured Internet transport protocol, AS2, by industry standard committee and its use by large influential organizations such as Wal-Mart and Target. Companies now have choices, they can continue to use a VAN, or they can exchange transactions directly and securely over the Internet. The cost of VAN services has dropped as a result of these changes.

However, data transport is only half of the story; companies must also perform data conversion between their back-end business systems, where their corporate data resides, and the electronic transactions. This step is called application integration, and is normally done by costly EDI translator software and requires the use of EDI specialists. XML (eXtensible Markup Language) has emerged as the data format of choice between systems and has been touted as the replacement for EDI. However, the jury is still out on XML, mainly due to the lack of standardization of XML transactions, and a lack of relief from the complex data conversions needed to integrate these transactions with back-end systems.

### BRIEF DESCRIPTION OF THE DRAWINGS

FIG. 1 is a system block diagram according to an example embodiment.

FIG. 2 is a block diagram of a data translation object according to an example embodiment.

FIG. 3 is a block diagram of a method according to an example embodiment.

FIG. 4 is a block diagram of a method according to an example embodiment.

### DETAILED DESCRIPTION

In the following detailed description, reference is made to the accompanying drawings that form a part hereof, and in which is shown by way of illustration specific embodiments in which the inventive subject matter may be practiced. These embodiments are described in sufficient detail to enable those skilled in the art to practice them, and it is to be understood that other embodiments may be utilized and that structural, logical, and electrical changes may be made without departing from the scope of the inventive subject matter. Such embodiments of the inventive subject matter may be referred to, individually and/or collectively, herein by the term “invention” merely for convenience and without intending to voluntarily limit the scope of this application to any single invention or inventive concept if more than one is in fact disclosed.

The following description is, therefore, not to be taken in a limited sense, and the scope of the inventive subject matter is defined by the appended claims.

The functions or algorithms described herein are implemented in hardware, software, or a combination of software and hardware in one embodiment. The software comprises computer executable instructions stored on computer readable media such as memory or other type of storage devices. The term “computer readable media” is also used to represent carrier waves on which the software is transmitted. Further, such functions correspond to modules, which are software, hardware, firmware, or any combination thereof. Multiple functions are performed in one or more modules as desired, and the embodiments described are merely examples. The software is executed on a digital signal processor, ASIC, microprocessor, or other type of processor operating on a system, such as a personal computer, server, a router, or other device capable of processing data including network interconnection devices.

Some embodiments implement the functions in two or more specific interconnected hardware modules or devices with related control and data signals communicated between and through the modules, or as portions of an application-specific integrated circuit. Thus, the exemplary process flow is applicable to software, firmware, and hardware implementations.

The present inventive subject matter includes systems, methods, and software to increase efficiencies in data exchange between various entities, such as trading partners in a supply chain. The efficiencies are increased by replacing data mappings with data translation objects for translating data between supply chain trading partner specific formats and a general, intermediate format. This elimination of data mappings reduces the amount of time, and the costs associated with that time, necessary to maintain data mappings used in exchanging data between supply chain trading partners. The minimum number of data translation objects necessary in the present inventive subject matter is equal to the number of participating trading partners. However, trading partners can have more than one data translation object. For example, a trading partner can have data translation objects for specific types of data transactions. Such specific types of data transactions can be for purchase orders, warehouse movements, shipping orders, or other types of transactions that include specific types of data.

The systems, methods, and software of the present inventive subject matter utilize data translation objects by instituting a general data format. Each trading partner then creates a data translation object for translating data to and from their proprietary formats to the general format. An example transaction according to one embodiment of the inventive subject matter includes a first trading partner transmitting data in the first trading partner's proprietary format(s) to a second trading partner via a transaction intermediary. The transaction intermediary receives the data and translates the data from the first trading partner's proprietary format(s) to the general format using a data translation object generated by the first trading partner. The transaction intermediary then translates the data from the general format to the second trading partner's proprietary format using a data translation object generated by the second trading partner. Finally, the data is either transmitted by the data intermediary to the second trading partner or placed by the data intermediary in a storage location for retrieval by the second trading partner. This embodiment, and others, are illustrated and further described below.

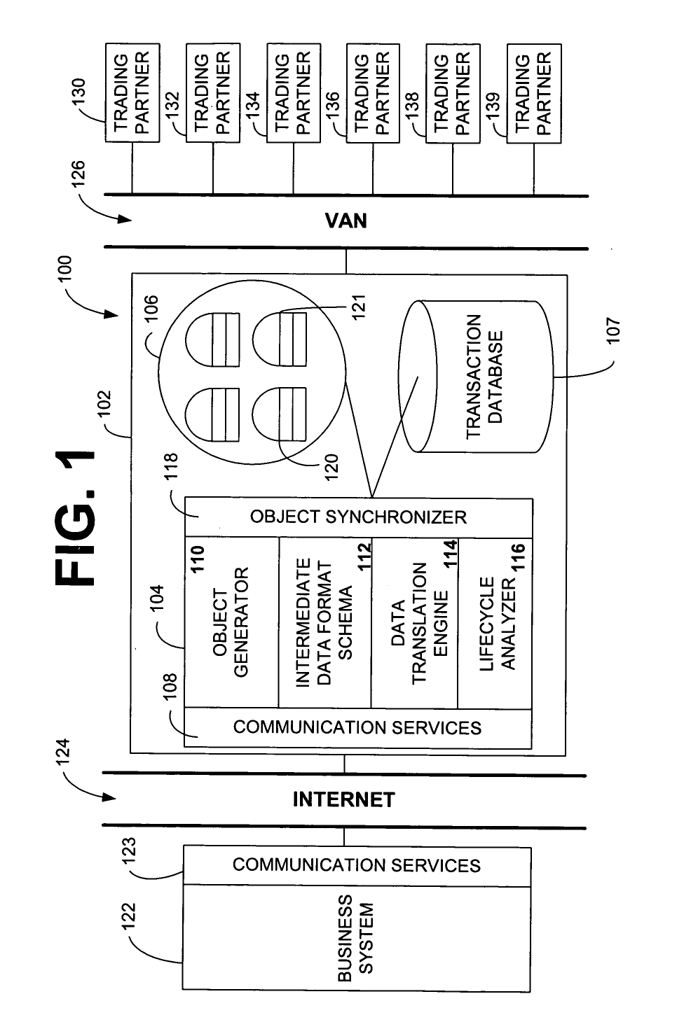

FIG. 1 is a system 100 block diagram according to an example embodiment. System 100 includes a transaction network 102 connected to one or more networks such as the Internet 124 or another network such as a Value Added Network (VAN) 126. The system 100 further includes trading partners 130, 132, 134, 136, 138, and 139 that connect to the transaction network 102 over the VAN 126, Internet 124, or other similar network type such as a wide area network (WAN) or local area network (LAN). The trading partners 130, 132, 134, 136, 138, and 139 each include a business system 122 that exchanges data with the transaction network 102. In some embodiments, some such the business systems, such as business system 122, exchange data using communication services 123 and 108, such as web services, between the business system 122 and the communications server 104 within the transaction network.

The transaction network 102 includes a communication server 104, data translation object storage 106, and a transaction database 107.

The data translation object storage 106 is a storage location within the transaction network 102 for storing data translation objects, such as data translation objects 120 and 121. Data translation objects 120 and 121 include relationship definitions for translating data to and from a trading partner proprietary data format and an intermediate data format schema as defined in an intermediate data format schema definition 112. These defined relationships include rules for translating data between a proprietary data format and the intermediate data format schema. Some of these defined relationships include arithmetic requirements and other requirements necessary for translating data.

The communication server 104 includes a data translation object generator 110 program, the intermediate data format schema definition 112, a data translation engine 114, and a transaction lifecycle analyzer 116. The communication server 104 of this embodiment further includes web services 108 and a data translation object synchronizer 118.

The data translation object generator 110 provides transaction network 102 participants the ability to generate data translation objects, such as data translation objects 120 and 121. Data translation objects generated by the data translation object generator 110 eliminate the duplicate works resulted from the one-to-one relationship between sender format and receiver format in traditional EDI type mappings. The data translation object generator 110 de-couples the relationship and allows the sender and receiver formats to be described in separate data translation objects. Once an entity generates a data translation object, that entity is automatically enabled to exchange data with any other entity having a data translation object in the system 100. In addition, any special data translation rules, arithmetic, and logical requirements are also described using the data translation object generator 110 and stored in their respective objects, such as data translation objects 120 and 121 stored in the data translation object storage 106.

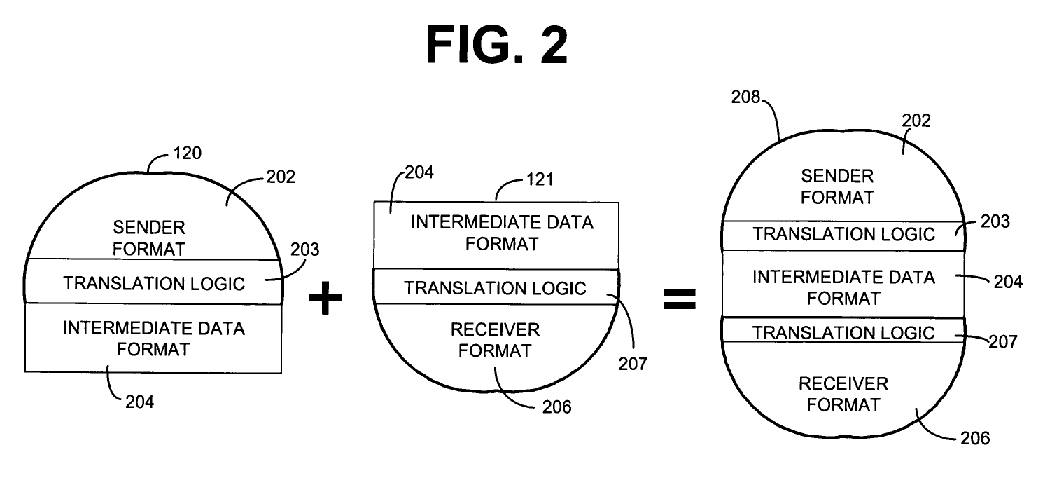

The intermediate data format schema definition 112 is a transaction network 102 specific data schema used as an intermediate data format during the data conversion process. The intermediate data format schema definition 112 becomes the glue that dynamically connects trading partner 130, 132, 134, 136, 138, and 139 data translation objects to one another. An example of how the intermediate data format schema definition 112 connects the trading partner 130, 132, 134, 136, 138, and 139 data format is illustrated in FIG. 2.

The data translation object synchronizer 118 is a tool used to keep data translation objects current and in sync with the data translation object storage 106. Data translation objects created or updated by the data translation object generator 110 are immediately registered with, and a copy is deposited to, the data translation object storage 106. Registered and stored data translation objects of trading partners 130, 132, 134, 136, 138, and 139 can be searched for and downloaded from the data translation object storage 106 by the data translation object synchronizer.

The data translation engine 114 operates to translate data communicated over the transaction network and received by the communication server 104 from a sender format to a receiver formal. The data translation engine uses data translation objects, such as data translation objects 120 and 121, to guide the data translation effort. Inbound data is translated from a sender format to the intermediate data format. Outbound data is then translated from the intermediate data format to a receiver format. Using these data translation objects within the data translation engine 114 allows data to be put in any outbound format that is defined in a data translation object.

An example of how the data translation objects are pieced together by the data translation engine 114 is illustrated in FIG. 2. Sender data translation object 120 includes a definition of a sender format 202 and translation logic 203 for translating data from the sender format 202 to the intermediate data format 204. Receiver data translation object 121 includes a definition of a receiver format 206 and translation logic 207 for translating data from the intermediate data format 204 to the receiver format 202. The translation logic 203 and 207, in various embodiments, can include a set of rules, mappings, logic, arithmetic, or other commands for translating data to and from the intermediate data format. The data translation objects 120 and 121 are then coupled to form a data translation object union 208 for translating data from the sender format 202 to the receiver format 206.

In some embodiments, the communications server 104 further includes a lifecycle analyzer 116 that operates in conjunction with the transaction database 107 to provide analytical abilities to transaction network 102 users and administrators. The transaction database 107 includes historical data relating to transactions processed by the transaction network 102. All transactions that pass through the communication server 104 and are processed by the data translation engine 114 are indexed and stored in the transaction database 107. Data in the transaction database 107 is accessible via the transaction lifecycle analyzer 116. The transaction lifecycle analyzer 116 allows users to drill down to search historical transactions. The transaction lifecycle analyzer 116 further allows users to view transactions throughout their lifecycles.

The communication server 104 also includes communications services 108 for communicating with systems of trading partners 130, 132, 134, 136, 138, and 139, such as business system 123 over a network. The network, in various embodiments, can include the Internet 124, a VAN 126, a WAN, a LAN, or virtually any other network type. The communication services 108 in one embodiment include web services. A web service is software designed to support interoperable machine-to-machine interaction over a network. Web services include an interface described in a machine-processable format called Web Services Description Language WSDL. Other systems interact with the web service in a manner prescribed by its description using Simple Object Access Protocols (SOAP) messages, typically conveyed using HTTP with an XML serialization in conjunction with other web-related standards. The use of web services allows integration with many systems such as Enterprise Resource Planning (ERP) systems. This integration is possible because ERP vendors have retooled their systems, or soon will. However, other methods of exchanging data directly between systems can be used.

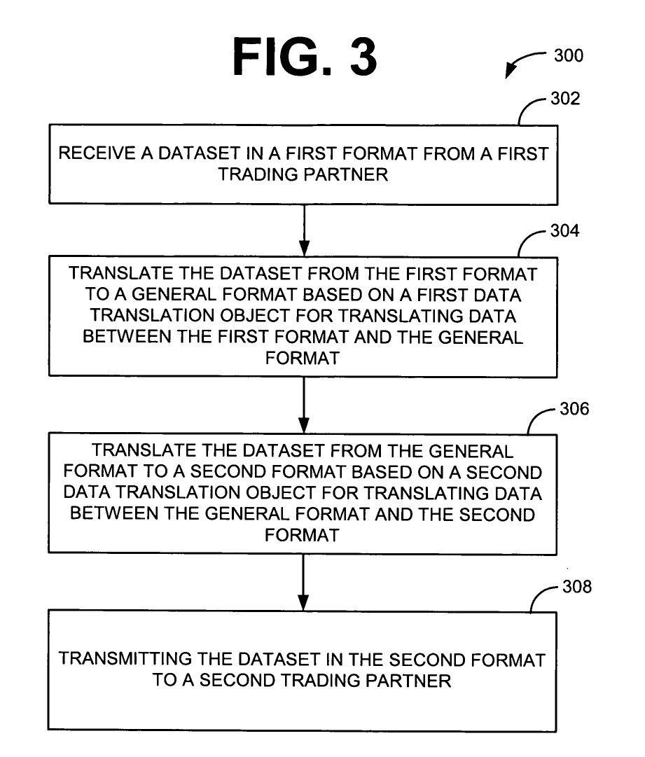

FIG. 3 is a block diagram of a method 300 according to an example embodiment. The method 300 includes receiving a dataset in a first format from a first trading partner 302 and translating the dataset from the first format to a general format based on a first data translation object for translating data between the first format and the general format 304. The method 300 further includes translating the dataset from the general format to a second format based on a second data translation object for translating data between the general format and the second format 306 and transmitting the dataset in the second format to a second trading partner 308.

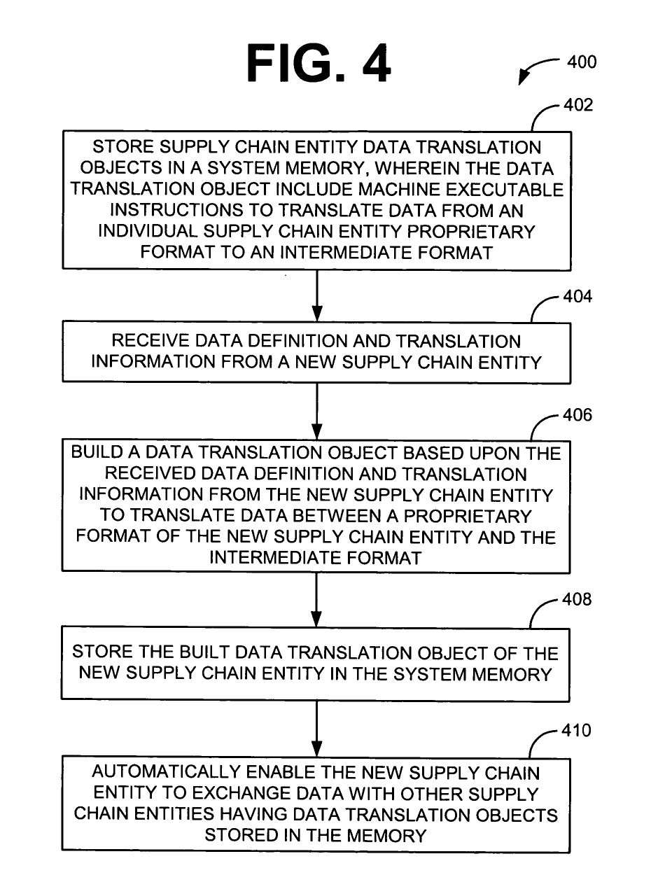

FIG. 4 is a block diagram of a method 400 according to an example embodiment. The method 400 includes storing supply chain entity data translation objects in a system memory, wherein data translation objects include machine executable instructions to translate data from an individual supply chain entity proprietary format to an intermediate format 402 and receiving data definition and translation information from a new supply chain entity 404. The method 400 further includes building a data translation object based upon the received data definition and translation information from the new supply chain entity to translate data between a proprietary format of the new supply chain entity and the intermediate format 406, storing the built data translation object of the new supply chain entity in the system memory 408, and automatically enabling the new supply chain entity to exchange data with other supply chain entities having data translation objects stored in the memory 410.

It is emphasized that the Abstract is provided to comply with 37 C.F.R. §1.72(b) requiring an Abstract that will allow the reader to quickly ascertain the nature and gist of the technical disclosure. It is submitted with the understanding that it will not be used to interpret or limit the scope or meaning of the claims.

In the foregoing Detailed Description, various features are grouped together in a single embodiment to streamline the disclosure. This method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

It will be readily understood to those skilled in the art that various other changes in the details, material, and arrangements of the parts and method stages which have been described and illustrated in order to explain the nature of this inventive subject matter may be made without departing from the principles and scope of the inventive subject matter as expressed in the subjoined claims.

What is claimed is:

1. A system comprising:
a connection to a computer network;
a database, wherein the database includes, for each of a plurality of supply chain entities, at least one data translation object to translate between each respective supply chain entity data format and an intermediate data format, further wherein the data translation objects include any entity specific special data translation rules, arithmetic, and logic encoded in machine executable instructions to translate data between a supply chain entity specific format and the intermediate format, the supply chain entity specific format being the format of the specific supply chain entity associated with the data translation object;
at least one translation computer program operable on the system to cause the system to:
receive supply chain data over the network connection from a first supply chain entity in a first format, the supply chain data addressed to a second supply chain entity,
translate the supply chain data from the first format to the intermediate data format using a data translation object associated with the first supply chain entity, and
translate the supply chain data to a second format using a data translation object associated with the second supply chain entity using at least one of the other data maps.

2. The system of supply chain communication of claim 1, wherein the computer network is the Internet.

3. The system of claim 1, wherein the logic of a data translation object further includes data mapping between an entity specific data format and the intermediate data format.

4. The system of claim 1, wherein the database further includes historical data representative of transactions processed by the system, the system further comprising:
at least one program operable on the system to facilitate retrieval and analysis of the historical data representative of transactions processed by the system.

5. The system of claim 1, further comprising:
at least one map generating computer program adapted to generate data translation objects and store them in the database.

6. The system of claim 1, wherein the at least one translation computer program is further operable on the system to cause the system to provide the second supply chain entity with the translated data.

7. The system of claim 6, wherein the computer program provides the translated data to the second supply chain entity by transmitting the translated data to the second supply chain entity via the network connection.

8. A method comprising:
translating a dataset from the first format of a first trading partner to a general format based on a first data translation object for translating data between the first format and the general format; and
translating the dataset from the general format to a second format of a second trading partner based on a second data translation object for translating data between the general format and the second format.

9. The method of claim 8, further comprising:
receiving the dataset the first trading partner via a network; and
transmitting the translated dataset to the second trading partner via the network.

10. The method of claim 9, wherein the receiving and transmitting includes receiving and transmitting over a network path that includes one or more of the Internet, a local area network, a wide area network, and a value added network.

11. The method of claim 8, wherein the first data translation object and the second data translation object couple together to form a data translation object union to translate data from the first format to the second format.

12. A system comprising:
a processor coupled to a bus;
a memory operatively coupled to the processor via the bus;
a network interface device operatively coupled to the processor and the memory via the bus; and
software, stored in the memory and operative on the processor, to cause the system to:
maintain data translation objects in the memory to translate data between a proprietary format of an entity and a general format, wherein a data translation object is maintained for each entity,
receive a dataset from a first entity for transmission to a second entity, the dataset received in the first entity's proprietary format,
translate the dataset from the first entity's proprietary format to the general format based on the first entity's data translation object,
translate the dataset from the general format to the second entity's proprietary format based on the second entity's data translation object, and
transmit the dataset in the second entity's proprietary format to the second entity.

13. The system of claim 12, wherein the software is further operable on the processor to cause the system to:
maintain a database of historical data representative of transactions processed by the system; and
facilitate retrieval and analysis of the historical data representative of transactions processed by the system.

14. The system of claim 12, wherein the software is further operable on the processor to cause the system to:
receive data definition and translation information from a new entity;
build a new data translation object based upon the received data definition and translation information to translate data between a format of the new entity and the general format; and
store the new data translation object in the memory.

15. A method comprising:
receiving a dataset in a first format from a first entity, wherein the dataset is addressed to a second entity; and
translating the dataset from the first format to a second format of the second entity, wherein the translating is performed according to data translation object union.

16. The method of claim 15, wherein the data translation object union includes a first data translation object of the first entity and a second data translation object of the second entity.

17. The method of claim 16, wherein the first and second data translation objects include instructions to translated the dataset to and from a general data format.

18. A method comprising:
storing supply chain entity data translation objects in a system memory, wherein data translation objects include machine executable instructions to translate data between an individual supply chain entity proprietary format and an intermediate format.

19. The method of claim 18, further comprising:
receiving data definition and translation information from a new supply chain entity;
building a data translation object based upon the received data definition and translation information from the new supply chain entity to translate data between a proprietary format of the new supply chain entity and the intermediate format; and
storing the new supply chain entity data translation object in the system memory.

20. The method of claim 19, wherein the new supply chain entity data translation object enables the new supply chain entity to exchange data with other supply chain entities having data translation objects stored in the memory.
